(19) United States
(12) Patent Application Publication
(10) Pub. No.: US 2019/0176549 A1
(43) Pub. Date: Jun. 13, 2019

(54) DEVICE, KIT AND RESPECTIVE METHOD OF DEPOSITION OF AN EXTRUDABLE MATERIAL ON A TIRE

(71) Applicant: FRANCESCO FELICIONI, ANCONA (IT)

(72) Inventor: FRANCESCO FELICIONI, ANCONA (IT)

(21) Appl. No.: 16/322,411

(22) PCT Filed: Aug. 8, 2017
(86) PCT No.: PCT/IB2017/054830

§ 371 Date: Jan. 31, 2019

(30) Foreign Application Priority Data
Aug. 9, 2016 (IT) 102016000083970

(51) Int. Cl. B60C 27/06

(52) U.S. Cl. CPC B60C 27/06

(57) ABSTRACT

A device (1) for deposition of an extrudable material (2) on the tire (100) of a vehicle (200), comprising at least one extrusion unit (3) configured to dispense the material (2) in a respective state of extrusion wherein the device (1) is configured to deposit the extrudable material (2) by the extrusion unit (3) on an outer surface portion (110) of the tire (100) so as to wrap it at least partially.

The present invention relates to a device for deposition of an extrudable material on the tire of a vehicle, a mounting kit for the above-mentioned device and a method for the deposition of an extrudable material on the tire.

In particular, the present invention relates to a device for deposition of an extrudable material on the tire of a vehicle and a respective method for realizing a temporary coverage on it having a high friction coefficient.

The present invention relates to a device for deposition of an extrudable material on the tire of a vehicle, the kit of the above-mentioned device and the respective method for realizing a temporary coverage on it to assist the vehicle circulation on snowy and icy road surfaces or in general on road surfaces having a low adherence, which compromise the circulation safety of the vehicle.

In the state of the art there are well-known products to increase the friction coefficient between tires and the road surface such as, e.g., snow chains.

Snow chains can be generally used on all vehicles such as cars, vans, minivans and coaches.

In the event that it is not possible to equip the vehicle with snow chains, there are also known spiked tires or tires with winter compound which, specially shaped, allow to compensate, at least partially, the absence of the metal mesh of the snow chains mentioned above.

All the devices to increase/assist the adherence between tire of the vehicle and road surface of the known type suffer from some limitations and drawbacks.

Particularly referring to snow chains, they must be installed manually on each tire of at least the drive wheels of the vehicle, especially when a condition of low adherence is created between tires and the road surface, typically when it snows or in conjunction with a sudden frost.

In this way, the driver or an occupant of the vehicle is forced to come out from the passenger compartment to perform the installation, exposing himself to the atmospheric agents, such as a blizzard and the cold.

In addition, the installation of the snow chains requires some knowledge and some notions of basic techniques which not all people have, and this represents a further limit in the use of snow chains as a device to increase/assist the adherence between tire of the vehicle and road surface. A less and less unusual example is that of vehicle drivers with a certain degree of disability who, therefore, would not be able to perform manoeuvres and/or the necessary gestures for the autonomous and correct installation of the traditional snow chains.

A further limit in the use of snow chains is that the installer is also exposed to the danger of the road and, thus, is exposed to the risk of being hit by other vehicle in transit, especially when the person is not clearly visible and/or the stationary vehicle for mounting is not properly signalled.

A further and different limit of the snow chains is that they are not an infallible system and sometimes they can break, compromising the geometry of the “web” of meshes placed on the tire. In this case, the problem is a frequent reduction of grip between tires and road surface, as well as the possibility that some parts of the broken chain can be thrown from the moving tire against the vehicle body and/or against other people outside it and/or may entangle in the mechanical/hydraulic/pneumatic parts of the vehicle's systems, such as, e.g., the braking system.

The object of the present invention is to solve the problems encountered in the known art proposing a device for deposition of an extrudable material on the tire of a vehicle, a mounting kit for the above-mentioned device and a method for the deposition of an extrudable material on the tire overcoming the limits and the drawbacks mentioned above.

In particular, it is an object of the present invention to provide a device for deposition of an extrudable material on the tire of a vehicle that allows the user to cover the tires of a vehicle without any manual action and with minimum effort, for example staying inside the passenger compartment of the vehicle itself.

It is a further object of the present invention to provide a mounting kit of the device for deposition of an extrudable material on the tire of a vehicle that is universal, that is suitable for all types of vehicle, and is easily installed as an aftermarket-type product without substantial modifications of the structure and/or the body of the same vehicle.

A further and different object of the present invention is to provide a method for deposition of an extrudable material on the tire of a vehicle in a simple, rapid and cost-effective manner compared with the realization and commercialization of traditional snow chains. In fact, the process of realizing known snow chains requires high energy consumption for steel processing and the manufacture of chain links as well as of the accessories (clamps, tensioners) required for mounting and using the same. The present invention thus has the additional advantage in terms of cost-effectiveness and eco-compatibility of the process for the deposition of extrudable material on the tires.

In particular, the present invention relates to a device for deposition of an extrudable material on the tire of a vehicle comprising at least one extrusion unit configured to deliver said material in a respective extrusion state. In particular, the device of the present invention is configured to deposit the extrudable material through the extrusion unit onto an outer surface portion of the tire so as to wrap it at least partially.

In addition, the present invention relates to the respective method for deposition of an extrudable material on the tire of a vehicle comprising the steps of:
providing a device for deposition of an extrudable material on the tire of the vehicle in accordance with the above description;
actuating the deposition device by means of a control member; successively or simultaneously
putting the vehicle in motion at a predetermined speed so as to allow a deposition of the extrudable material in the state of extrusion by means of the extrusion unit on an outer surface portion of the tire so as to wrap it at least partially;
turning off the deposition device by means of the control member;
letting the extrudable material harden to go from the extrusion state mentioned above to the solid state.

The dependent claims correspond to possible embodiments of the invention.

This description is provided with reference to the accompanying figures, also provided only by way of non-limiting example, wherein:

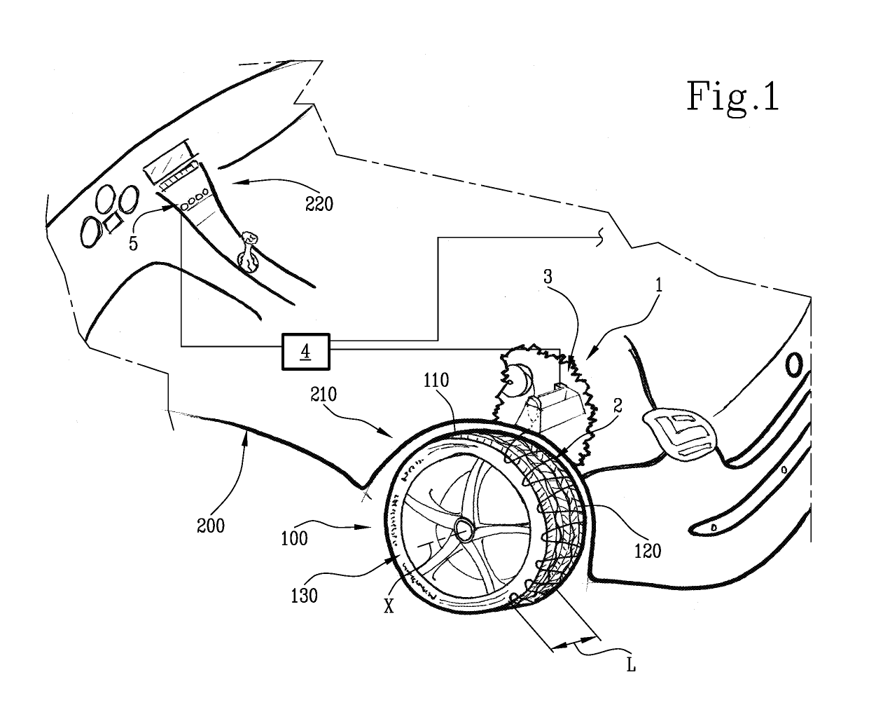

FIG. 1 is a schematic perspective view of the device for deposition according to the present invention;

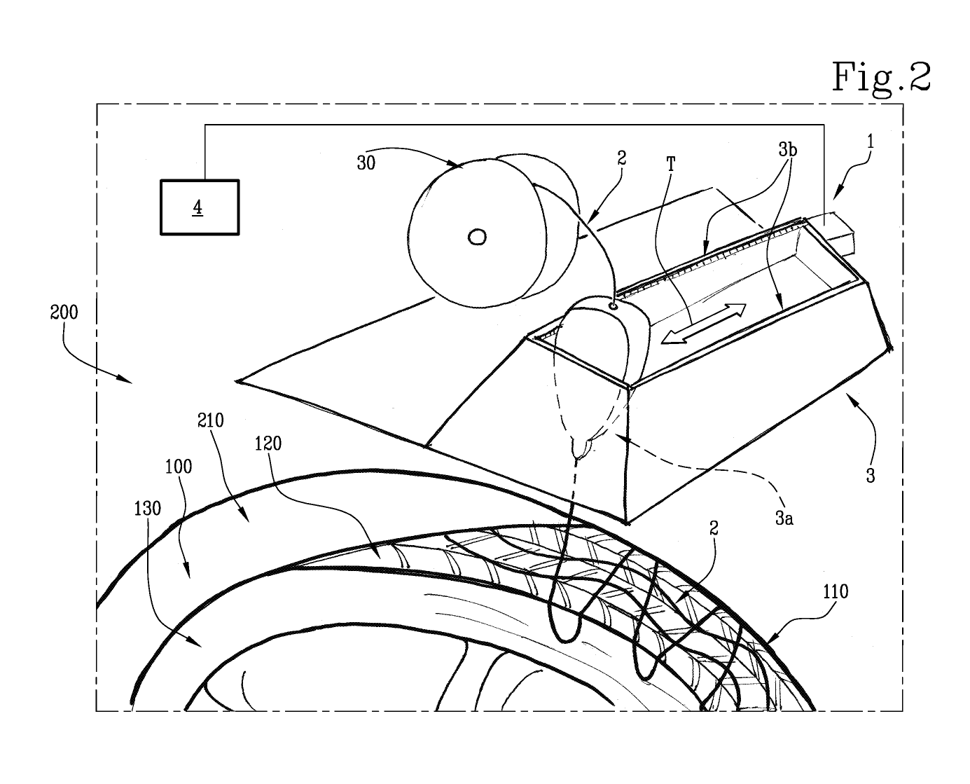

FIG. 2 is a detailed view of the device for deposition of FIG. 1;

The present invention, as mentioned above, relates to a device 1 for deposition of an extrudable material 2 on a tire 100 of a vehicle 200 as illustrated by way of example in the accompanying FIG. 1.

In accordance with the invention, the device 1 for deposition can be used for each tire 100 of the vehicle 200 without particular limitations and/or impediments. Preferably, the device 1 for deposition can be carried and/or installed on board of the vehicle 200 at a respective tire 100. Even more preferably, the device 1 for deposition can be integrated with a structural portion of a wheel arch 210 of the vehicle 200.

In more detail, the device 1 comprises at least one extrusion unit 3 configured to dispense the material 2 in a respective extrusion state.

In fact, any material suitable for extrusion has specific chemical/physical and rheological characteristics: the expression “extrusion state” is meant to signify that the extrusion unit 3 is configured to extrude the selected extrudable material 2 in the correct conditions of extrusion for that specific material.

By way of non-limiting example, the extrudable material 2 may include a plastic polymer, a biodegradable or compostable material (PLA) or other types of high friction coefficient and extrudable substances, without excluding also a polymer compound identical to and/or compatible with that used to make the same tires 100 of the vehicle 200. In accordance with the invention, the extrudable material 2 is a material with a high friction coefficient.

In particular, the device 1 for deposition is configured to deposit the extrudable material 2 by means of the aforesaid extrusion unit 3 on an outer surface portion 110 of the tire so as to wrap it at least partially.

Referring to the extrusion unit 3, it is preferably configured to heat the extrudable material 2 and bring it to the pre-established extruded state.

In this case, the extrudable material 2 is a material in a liquid or semi-liquid state extrudable by heating and is in a solid state in an operating condition of temperature lower than that of extrusion. Preferably, this temperature is approximately equal to that of the tire 100.

In other words, the extrudable material 2 preferably requires a heating step prior to extrusion and subsequently, in order to be effective, it must cool at least to the operating temperature of the tire on which it has been deposited.

Preferably, the extrusion unit 3 is configured to feed the extrudable material 2 in a liquid or semi-liquid extrusion state, and further comprises crosslinking means (not shown in the accompanying figures) of the material 2 to solidify the material 2 once it is deposited on the tire 100.

In accordance with the invention, the extrusion unit 3 is configured to perform a fused deposition modelling (also identifiable by the acronym FDM) of the extrudable material 2.

In particular, the extrusion unit 3 comprises an extrusion nozzle 3a and guiding means 3b configured to allow controlled translation at least of the nozzle 3a. Preferably, the extrusion nozzle 3a is configured to extrude the extrudable material 2 in the form of a full cord or string, with the possibility of modulating the dispensing by alternating fragmented stretches of string and empty stretches or by delivering a single seamless string of material 2.

By way of non-limiting example, such configuration of the extrusion nozzle 3a is illustrated in the appended FIGS. 1 and 2. In accordance with the invention, a different embodiment of the device 1, not shown in the appended figures, comprises an extrusion nozzle 3a configured to deposit the extrudable material 2 in the form of a film or thin foil or any other form having even a partial or lower width, preferably equal to or greater than a width “L” of a tread 120 of the tire 100.

Preferably, the guiding means 3b are configured so as to allow said controlled translation for a stretch at least equal to and/or greater than the above-mentioned width “L” of the tread 120 of the tire 100. In other words, the extrusion unit 3 is configured so that the controlled translation of the nozzle 3a allows to overcome at least the tread 120 of the tire 100 and possibly allows a deposition of the extrudable material 2, for example also on a portion of a shoulder 130 (internal and/or external) of the tire 100, as illustrated by way of non-limiting example in the appended FIGS. 1 and 2. Preferably, the guiding means 3b are configured to allow controlled translation at least of the nozzle 3a along a predetermined dispensing direction “T”, as illustrated by way of example in the appended FIG. 2.

In accordance with the invention, the combination of a relative movement between the tire 100 (rotating about its axis “X”) and the extrusion nozzle 3a (translating along the dispensing direction “T”) allows to achieve many different forms of deposition of the extrudable material 2, allowing in fact to obtain a net or mesh of material 2 each time different (desired and predetermined) and adapted to the possible adherence conditions between the tire 100 and the road surface.

In accordance with the invention, in an embodiment not shown in the appended figures, the extrusion nozzle 3a is movable both along the dispensing direction “T” and with respect to a fulcrum allowing the same to perform an oscillation of predetermined amplitude arranged transversely to the dispensing direction “T”, preferably an oscillation of predetermined amplitude arranged perpendicularly to the dispensing direction “T”. The combination of the movements of translation of the nozzle 3 along the dispensing direction “T”, oscillation perpendicularly to the dispensing direction “T”, and possible rotation of the tire 100 around the axis “X”, allows to obtain numerous and different geometries of the material 2 deposited on the tire 100, for example replicating a predetermined design that allows to obtain a superior adhesion to road surface.

Particularly, the device 1 for deposition of the present invention is configured to deposit the extrudable material 2 in the state of extrusion in correspondence to at least one portion of a tread 120 of the tire 100 of the vehicle 200 in a configuration of tire mounted on the vehicle 100 and in rotation around its own axis “X”.

In other words, the device 1 for deposition in a configuration installed on board of the vehicle 200 at one or more of the tires 100 of the vehicle 200 allows the deposition of the material 2 by using the relative movement of the tire 100 rotating around its rotation axis “X”, for example when the vehicle is moving and the device 1 for deposition is attached to a structural part of the body of the vehicle 200.

In an embodiment of the invention, illustrated in the appended FIGS. 1 and 2, the dispensing direction “T” is arranged parallel with respect to the above-mentioned rotation axis “X” of the tire 100 in a configuration wherein the device 1 for deposition is precisely integrated with a structural portion of a wheel arch 210 of the vehicle 200.

According to a different embodiment comprised in the inventive concept of the present invention, the dispensing direction “T” is arranged transversely, preferably perpendicular, with respect to the rotation axis “X” of the tire 100 in a configuration wherein the deposition device 1 is integrated with a structural portion of a wheel arch 210 of the vehicle 200.

In order to regularly dispense the extrudable material 2, the extrusion unit 3 comprises at least one accumulation member 3c of the extrudable material 2 configured to release the extrudable material 2 through the extrusion nozzle 3a, preferably in one operating configuration of deposition of the extrudable material 2 on the tire 100.

Preferably, the accumulation member 3c comprises a spool of extrudable material 2 in the form of a string, as illustrated schematically in the appended FIG. 2.

In accordance with the invention, the accumulation member 3c can dispense the extrudable material 2 in the form of fingers or cartridges which can be inserted into a suitable housing of the extrusion unit 3 (not shown in the appended figures).

In greater detail, in accordance with the invention, the device 1 for deposition comprises control means 4 connected to the extrusion unit 3, wherein the control means 4 are configured to handle the extrusion unit 3 in an operational configuration of deposition of the extrudable material 2 on the tire 100.

Preferably, control means 4 can be connected to an electrical system of the vehicle 200.

The control means 4 comprise circuit elements and sensors suitable for determining the operating condition of the extrusion unit 3 to actuate and/or adapt its operating parameters in accordance with a predetermined deposition procedure.

The control means 4, preferably in conjunction with the guiding means 3b, allow the extrusion and deposition of the material 2 in accordance with the characteristics of the tire 100 itself. In fact, the device 1 for deposition is configured to deposit the material 2 on the tire 100 in accordance with a predetermined logic depending on the type of tire 100, on the size of the grooves, on the compound, on the use for which the same tire 100 is intended. In greater detail, the device 1 for deposition comprises means for acquiring the specific characteristics of a tire 100 mounted on the vehicle 200 and drawing from a set of operating data the correct information to activate at least the operation of the control means 4. Advantageously, the device 1 for deposition of the present invention is configured to store geometric, dimensional and compound data for the deposition of extrudable material 2 for the coverage of each type of vehicle 200 and/or environment or environmental condition of use of the same.

The device 1 for deposition further comprises a control member 5 configured to allow a remote control of the control means 4 by a user directly from a control station and/or a dashboard 220 of the vehicle 200. According to the invention, a pressure of the remote control member 5 by a user corresponds to activating or deactivating the device 1, for example to perform a deposition on the tires 100 of the vehicle 200 or to interrupt this operation of deposition if already in progress. In this way, the user, driver or passenger of the vehicle can activate/deactivate the device 1 for deposition by conveniently staying in the passenger compartment of the vehicle 200, without becoming exposed to the atmospheric conditions outside the passenger compartment, such as for example a blizzard.

In accordance with the invention, the device 1 comprises a plurality of extrusion units 3 arranged in correspondence with respective tires 100 of the vehicle 200. Preferably, the extrusion units 3 are arranged in correspondence with respective tires 100 of respective drive wheels of vehicle 200.

Advantageously, the device 1 for deposition can be mounted on the vehicle 200 at a wheel arch 210 of a respective tire 100 regardless of whether the latter is mechanically connected to a motor of the vehicle 200 or not, that is, whether the latter is a tire 100 of a motor axis or not. In this configuration of the device 1 for deposition, each extrusion unit 3 is operative at a respective tire 100 of the vehicle 200 and the control member 5 is configured to allow a remote control of the control means 4 configured to activate the extrusion units 3, for example, simultaneously or sequentially, or by activating only some extrusion units 3 and excluding others.

In accordance with the invention, in a different non-illustrative embodiment of the present invention, the device 1 for deposition is configured to deposit granular material on the surface of a tire in order to increase the friction between the tire itself and the road surface. In particular, the material to be deposited may comprise a suspension similar to the one used to make the abrasive surface of sandpaper.

Always in accordance with the invention, the extrusion unit 3 of the present invention in this case is configured to simultaneously deposit the granular material together with a component of adhesive material to promote adhesion between the granular material and the surface of the tire 100 itself.

In accordance with the invention, the granular material could also be deposited on the surface of the tire 100 by gravity drop, since the extrusion/dispensing nozzle would be positioned above the tire 100 itself. According to the invention, a kit for a device 1 for deposition of an extrudable material 2 on the tire 100 of a vehicle 200 is also defined, comprising:
at least a device 1 for deposition according to the description above;
an electric wiring to allow the connection of the device 1 to an electrical system of the vehicle 200;
a plurality of reserve accumulation members 3c to allow the replacement of the accumulation members 3c once exhausted, due, e.g., to a prolonged usage of the device 1 itself.

According to the present invention, a deposition method 1 of an extrudable material 2 on the tire 100 of a vehicle 200 is also defined, comprising the steps of:
providing a device 1 for deposition of an extrudable material 2 on the tire 100 of a vehicle 200 in accordance with the above description concerning the kit and/or the device 1 for deposition;
actuating the device 1 for deposition by means of the control member 5; successively or simultaneously
putting the vehicle 200 in motion at a predetermined speed so as to allow a deposition of the extrudable material 2 in the state of extrusion by means of the extrusion unit 3 on an outer surface portion 110 of the tire 100 so as to wrap it at least partially;
turning off the device 1 for deposition by means of the control member 5;
letting the extrudable material 2 harden to go from said extrusion state to a solid state.

The present invention has achieved the intended purposes.

Advantageously, the device for deposition of the present invention allows for temporary coverage of the tires of a vehicle in order to increase the friction coefficient between the tires and the road surface.

Advantageously, the device for deposition of the present invention allows to create a temporary coverage on the tires of a vehicle to allow it to proceed on low-adhesion road surfaces such as snowy or icy road surfaces or similar without the driver being required to abandon the passenger compartment or to have technical and/or manual notions of any kind.

Advantageously, the device for deposition can be easily installed on board of a vehicle and can be installed in any point at one or more tires of the same.

Advantageously, the device for deposition of the present invention is configurable in such a way as to provide temporary coverage of a high friction coefficient extrudable material for each type of tire, both in terms of size and in terms of intended use (for example, in the case it is an off-road tire rather than a tire of a trailer or a caravan).

Advantageously, the device for deposition of the present invention is configured so that even a person with a limited mobility and/or having a certain degree of disability can easily, quickly and safely equip the vehicle with a temporary coverage of an extrudable material with high friction coefficient, as described above.

Advantageously, the device for deposition of the present invention is configured so that the vehicle, during the deposition of the extrudable material on the tire(s), can simply pull over along a roadway (possibly by activating the intermittent emergency light signal) without having to place a danger sign along the same road.

Advantageously, the kit of a device for deposition of the present invention allows to implement any vehicle with a device for deposition of a extrudable material on the tire of a vehicle without the need for significant structural changes on the vehicle itself.

Advantageously, the deposition method of an extrudable material according to the present invention allows for a temporary coverage which can be adapted to any type of tire and is intended to increase and/or promote greater friction between tire(s) of a vehicle and the road surface.

1. Device (1) for deposition of an extrudable material (2) on the tire (100) of a vehicle (200), comprising at least one extrusion unit (3) configured to dispense said material (2) in a respective state of extrusion wherein said device (1) is configured to deposit said extrudable material (2) by said extrusion unit (3) on an outer surface portion (110) of said tire (100) so as to wrap it at least partially.

2. Device (1) according to claim 1, wherein said extrusion unit (3) is configured to heat said extrudable material (2) and take it to said state of extrusion, said extrudable material (2) being an extrudable material in a liquid or semi-liquid state by heating and being in a solid state in an operating condition of temperature about equal to that of said tire (100).

3. Device (1) according to claim 1, wherein said extrusion unit (3) is configured to feed said extrudable material (2) in a state of liquid or semi-liquid extrusion, said extrusion unit (3) also comprising means of crosslinking of the extrudable material to solidify the material (2) itself when deposited on the tire (100).

4. Device (1) according to claim 2, wherein said extrusion unit (3) is configured for the fused deposition modelling (FDM) of said extrudable material (2), said extrudable material (2) being a high friction coefficient polymer.

5. Device (1) according to claim 1, wherein said device (1) is transportable and/or installable on board of said vehicle (200) in correspondence of said tire (100); said device (1) being integrated with a structural portion of a wheel arch (210) of said vehicle (200).

6. Device (1) according to claim 5, configured to deposit said extrudable material (2) in said state of extrusion in correspondence to at least one portion of a tread (120) of said tire (100) of the vehicle (200), preferably in a configuration of said tire (100) in rotation around its own axis (X).

7. Device (1) according to claim 1, wherein said extrusion unit (3) comprises an extrusion nozzle (3a) and guiding means (3b) configured to allow a controlled translation of at least said nozzle (3a) along a predetermined dispensing direction (T).

8. Device (1) according to claim 7, wherein said dispensing direction (T) is arranged parallel with respect to a rotation axis (X) of said tire (100) in a configuration of said deposition device (1) integrated with a structural portion of a wheel arch (210) of said vehicle (200).

9. Device (1) according to claim 7, wherein said dispensing direction (T) is arranged transversely with respect to the rotation axis (X) of said tire (100) in a configuration of said deposition device (1) integrated with a structural portion of a wheel arch (210) of said vehicle (200).

10. Device (1) according to claim 8, wherein said guiding means (3b) are configured in such a way as to allow said controlled translation for a stretch equal and/or greater than the width (L) of a tread (120) of said tire (100).

11. Device (1) according to claim 1, wherein said extrusion unit (3) comprises at least one accumulation member (3c) of said extrudable material (2) configured to release said extrudable material (2) through said extrusion nozzle (3a) in one operating configuration of deposition of said extrudable material (2) on said tire (100).

12. Device (1) according to claim 11, wherein said accumulation member (3c) comprises at least one spool, one finger, or one cartridge of said material (2), extrudable in the form of a string.

13. Device (1) according to claim 1, comprising control means (4) connected to said extrusion unit (3) and configured to manage said extrusion unit (3) in an operating configuration of deposition of said extrudable material (2) on said tire (100), said control means (4) being connectable to an electrical system of said vehicle (200).

14. Device (1) according to claim 13, comprising a control member (5) configured to allow a remote control of said control means (4) by a user directly from a control station and/or a dashboard (220) of said vehicle (200).

15. Device (1) according to claim 1, wherein said device (1) comprises a plurality of extrusion units (3) arranged at respective tires (100) of said vehicle (200), preferably said extrusion units (3) being arranged at respective tires (100) corresponding to the drive wheels of the vehicle (200).

16. Kit for a device (1) for deposition of an extrudable material (2) on the tire (100) of a vehicle (200), comprising:
at least one deposition device (1) in accordance with claim 1;
an electric wiring to allow the connection of said device (1) to said electrical system of said vehicle (200);
a plurality of reserve accumulation members (3c) to allow the replacement of the accumulation members (3c) once exhausted.

17. Deposition method (1) of an extrudable material (2) on the tire (100) of a vehicle (200), comprising the steps of:
providing a deposition device (1) of an extrudable material (2) on the tire (100) of said vehicle (200) in accordance with claim 1;
actuating said deposition device (1) by means of said control member (5); successively or simultaneously
putting said vehicle (200) in motion at a predetermined speed and/or putting said tires (100) in rotation so as to allow a deposition of said extrudable material (2) in said state of extrusion by means of said extrusion unit (3) on an outer surface portion (110) of said tire (100) so as to wrap it at least partially;
turning off said deposition device (1) by means of said control member (5);
letting said extrudable material (2) harden to go from said extrusion state to said solid state.
